(19) United States
(12) Patent Application Publication
(10) Pub. No.: US 2025/0038617 A1
(43) Pub. Date: Jan. 30, 2025

(54) VEHICLE WHEEL DRIVE DEVICE

(71) Applicant: DENSO CORPORATION, Kariya-city (JP)

(72) Inventors: MASASHI MATSUDA, Kariya-city (JP); YUKI MAWATARI, Kariya-city (JP); NORIYUKI FUKAYA, Kariya-city (JP)

(21) Appl. No.: 18/919,213

(22) Filed: Oct. 17, 2024

Related U.S. Application Data
(63) Continuation of application No. PCT/JP2023/011174, filed on Mar. 22, 2023.

(30) Foreign Application Priority Data
Apr. 19, 2022 (JP) 2022-068748

(51) Int. Cl. H02K 7/102; B60B 27/00; B60K 7/00; F16D 55/225; F16D 65/00; F16D 65/02; F16D 65/12; H02K 5/173; H02K 21/22

(52) U.S. Cl. CPC H02K 7/102; B60B 27/0015; B60B 27/0052; B60K 7/0007; F16D 55/225; F16D 65/0068; F16D 65/123; H02K 5/1737; H02K 21/22; B60B 2900/113; B60B 2900/114; B60B 2900/212; B60B 2900/513; B60K 2007/0092; F16D 2065/1388

(57) ABSTRACT

A vehicle wheel drive device includes: a rotary electric machine that is received on a radially inner side of a vehicle wheel shaped in a cylindrical tubular form and is configured to rotate the vehicle wheel; and a brake device that includes a brake disc and a brake caliper. The brake device is configured to generate a braking force relative to the vehicle wheel. The rotary electric machine includes a rotor and a stator which are opposed to each other in a radial direction. A hollow space is formed on a radially inner side of a magnetic circuit unit that is formed by the rotor and the stator. The brake device is placed in the hollow space in a state where the brake caliper is fixed to an axial end surface of the stator which faces in an axial direction, and the brake disc is rotatable integrally with the rotor.

### CROSS REFERENCE TO RELATED APPLICATIONS

This application is a continuation application of International Patent Application No. PCT/JP2023/011174 filed on Mar. 22, 2023, which designated the U.S. and claims the benefit of priority from Japanese Patent Application No. 2022-068748 filed on Apr. 19, 2022. The entire disclosures of all of the above applications are incorporated herein by reference.

### TECHNICAL FIELD

The present disclosure relates to a vehicle wheel drive device.

### BACKGROUND

Previously, there has been proposed an in-wheel motor that has a rotary electric machine placed on a radially inner side of a vehicle wheel. Furthermore, there has been proposed a technique of integrally assembling a brake device with a vehicle wheel drive device having the in-wheel motor. The in-wheel motor includes: an outer rotor fixed at an inside of a rim of a wheel frame; and an inner stator placed at an inside of the outer rotor. Furthermore, the vehicle wheel drive device includes a disc brake as the brake device. This disc brake includes: a brake disc which is installed to an end portion of the outer rotor that faces an outer side in a vehicle width direction; and a caliper which is installed to an end portion of the inner stator that faces the outer side in the vehicle width direction.

### SUMMARY

This section provides a general summary of the disclosure, and is not a comprehensive disclosure of its full scope or all of its features.

According to the present disclosure, there is provided a vehicle wheel drive device that includes a rotary electric machine and a brake device. The rotary electric machine is received on a radially inner side of a vehicle wheel to rotate the vehicle wheel. The brake device includes a brake disc and a brake caliper. The rotary electric machine includes a rotor and a stator which are opposed to each other in a radial direction. A hollow space is formed on a radially inner side of a magnetic circuit unit that is formed by the rotor and the stator. The brake device is installed in the hollow space in a state where the brake caliper is fixed to an axial end surface of the stator which faces in an axial direction, and the brake disc is rotatable integrally with the rotor.

### BRIEF DESCRIPTION OF DRAWINGS

The drawings described herein are for illustrative purposes only of selected embodiments and not all possible implementations, and are not intended to limit the scope of the present disclosure.

FIG. 1 is a perspective view showing an overall view of a vehicle wheel unit.

FIG. 2 is a longitudinal cross-sectional view of the vehicle wheel unit.

FIG. 3 is an exploded perspective view of the vehicle wheel unit.

FIG. 4 is a longitudinal cross-sectional view of a rotary electric machine.

FIG. 5 is a perspective view of a stator.

FIG. 6 is a longitudinal cross-sectional view of the vehicle wheel unit.

FIG. 7 is a front view showing an installed state of the vehicle wheel unit on a vehicle.

FIG. 8 is a perspective view of the vehicle wheel unit.

FIG. 9 is a transverse cross-sectional view of a stator holder.

FIG. 10 is a longitudinal cross-sectional view of the vehicle wheel unit.

### DETAILED DESCRIPTION

Previously, there has been proposed an in-wheel motor that has a rotary electric machine placed on a radially inner side of a vehicle wheel. Furthermore, there has been proposed a technique of integrally assembling a brake device with a vehicle wheel drive device having the in-wheel motor. The in-wheel motor includes: an outer rotor fixed at an inside of a rim of a wheel frame; and an inner stator placed at an inside of the outer rotor. Furthermore, the vehicle wheel drive device includes a disc brake as the brake device. This disc brake includes: a brake disc which is installed to an end portion of the outer rotor that faces an outer side in a vehicle width direction; and a caliper which is installed to an end portion of the inner stator that faces the outer side in the vehicle width direction.

In the case where the brake device is integrally provided in the vehicle wheel drive device having the in-wheel motor structure, it is necessary to suitably provide the brake device to the rotary electric machine that is the in-wheel motor. In this respect, there is room for improvement over the existing technology.

According to a first aspect of the present disclosure, there is provided a vehicle wheel drive device including:
a rotary electric machine that is received on a radially inner side of a vehicle wheel shaped in a cylindrical tubular form, wherein the rotary electric machine is configured to rotate the vehicle wheel; and
a brake device that includes a brake disc and a brake caliper, wherein the brake device is configured to generate a braking force relative to the vehicle wheel, wherein:
the rotary electric machine includes a rotor and a stator which are opposed to each other in a radial direction;
a hollow space is formed on a radially inner side of a magnetic circuit unit that is formed by the rotor and the stator; and
the brake device is installed in the hollow space in a state where the brake caliper is fixed to an axial end surface of the stator which faces in an axial direction, and the brake disc is rotatable integrally with the rotor.

The vehicle wheel drive device includes: the rotary electric machine that is received on the radially inner side of the vehicle wheel; and the brake device that is configured to generate the braking force relative to the vehicle wheel. Furthermore, in the rotary electric machine, the hollow space is formed on the radially inner side of the magnetic circuit unit that is formed by the rotor and the stator. The brake device is installed in the hollow space in the state where the brake caliper is fixed to the axial end surface of the stator which faces in the axial direction, and the brake disc is rotatable integrally with the rotor. By installing the brake device in the hollow space of the magnetic circuit unit, the axial length of the vehicle wheel drive device can be reduced. Furthermore, by fixing the brake caliper to the axial end surface of the stator, the fixing structure of the brake caliper can be simplified, and the installation of the brake device into the hollow space can be suitably executed. As a result, the brake device can be suitably installed in the vehicle wheel drive device having the in-wheel motor structure.

According to a second aspect, there is provided the vehicle wheel drive device according to the first aspect, wherein:
the stator includes:
   a plurality of stator windings; and
   a holder member that is shaped in a cylindrical tubular form and holds the plurality of stator windings; and
the brake caliper includes a fixing portion that is fixed to the axial end surface of the stator, and the brake caliper is installed in a state where the brake caliper is received in the hollow space and is fixed to the stator through the fixing portion.

The brake caliper is fixed to the axial end surface of the stator at the fixing portion, and in this fixed state, the brake caliper is installed in the hollow space of the magnetic circuit unit. In this case, while the axial length is shortened by receiving the brake caliper in the hollow space, the fixing work for fixing the fixing portion to the axial end surface of the stator from the outside of the vehicle wheel is made possible, thereby improving the workability for installing the brake caliper.

According to a third aspect, there is provided the vehicle wheel drive device according to the first or second aspect, wherein:
the vehicle wheel includes a wheel frame, wherein the wheel frame includes:
   a hub that forms a rotational center of the vehicle wheel; and
   a rim that is shaped in a cylindrical tubular form and surrounds the hub;
the rotary electric machine is placed on a radially inner side of the rim in a state where the rotor is fixed to the hub;
the vehicle wheel drive device includes a shaft that is coaxial with the hub; and
the brake disc is fixed to the shaft at the hollow space.

In the state where the rotor is fixed to the hub of the wheel frame, the rotary electric machine is placed on the radially inner side of the rim. Furthermore, in the hollow space of the magnetic circuit unit, the brake disc is fixed to the shaft installed coaxially with the hub. In this case, the braking torque, which is generated by the frictional braking to the brake disc, does not act directly on the rotor during the operation of the brake device. Therefore, it is possible to limit deformation, etc. of the rotor caused by the braking torque.

According to a fourth aspect, there is provided the vehicle wheel drive device according to the third aspect, including a hub bearing that is fixed to the hub, wherein:
the rotor includes:
   a rotor carrier that is shaped in a cylindrical tubular form; and
   a magnetic flux generator that is fixed to the rotor carrier;
the rotor carrier has an end plate portion that is formed at an axial end portion of the rotor carrier;
a stationary portion of the hub bearing is coupled to the stator;
a rotatable portion of the hub bearing is coupled to the end plate portion of the rotor carrier; and
the end plate portion has two opposed surfaces which are opposed to each other, and the hub bearing and the shaft are installed to one of the two opposed surfaces of the end plate portion which faces the hollow space.

The relative rotation between the stator and the rotor is made possible by the hub bearing. Specifically, the stationary portion of the hub bearing is coupled to the stator, and the rotatable portion of the hub bearing is coupled to the end plate portion of the rotor carrier. The hub bearing and the shaft are installed to the one of the two opposed surfaces of the end plate portion which faces the hollow space of the magnetic circuit unit. In this case, the hollow space of the magnetic circuit unit can be suitably used as the receiving area of the brake device and the hub bearing.

According to a fifth aspect, there is provided the vehicle wheel drive device according to the third or fourth aspect, wherein:
the stator includes a plurality of stator windings;
at a first coil end portion of the plurality of stator windings which faces one side in the axial direction, an axial end portion of each corresponding one of the plurality of stator windings is radially inwardly bent, and at a second coil end portion of the plurality of stator windings which faces another side that is opposite to the one side in the axial direction, an axial end portion of each corresponding one of the plurality of stator windings is radially outwardly bent;
the stator is installed in a state where the first coil end portion is placed closer to the hub in the axial direction than the second coil end portion, and the second coil end portion is placed farther from the hub in the axial direction than the first coil end portion; and
the rotor is placed on a radially outer side of the stator, and the brake device is fixed in a state where the brake device is inserted on a radially inner side of the stator from a side of the stator where the second coil end portion is placed.

At the first coil end portion, the axial end portion of each corresponding one of the plurality of stator windings is radially inwardly bent, and at the second coil end portion, the axial end portion of each corresponding one of the plurality of stator windings is radially outwardly bent. Also, the stator is installed in the state where the first coil end portion is placed closer to the hub in the axial direction than the second coil end portion, and the second coil end portion is placed farther from the hub in the axial direction than the first coil end portion. Furthermore, the rotor is placed on the radially outer side of the stator, and the brake device is fixed in the state where the brake device is inserted on the radially inner side of the stator from the side of the stator where the second coil end portion is placed. In this case, by radially bending the axial end portion of each corresponding one of the plurality of stator windings, it is possible to suitably arrange the plurality of stator windings while limiting interferences among phase windings. Furthermore, it is possible to assemble the rotor to the stator from the one side in the axial direction, and it is also possible to assemble the brake device to the stator from the other side in the axial direction.

According to a sixth aspect, there is provided the vehicle wheel drive device according to any one of the first to fifth aspects, wherein:
the brake caliper includes a first portion and a second portion which are respectively placed on one side and another side of the brake disc in the axial direction;
the first portion and the second portion are joined together through a connecting portion at a location that is on a radially outer side of the brake disc; and
in an installed state where the vehicle wheel drive device is installed to a vehicle, the vehicle wheel drive device is configured to satisfy one of the following conditions:
   the connecting portion is placed above a horizontal line which passes through a rotational center of the vehicle wheel; and
   the connecting portion does not intersect with a gravitational line, which passes through the rotational center of the vehicle wheel, in a state where at least a part of the connecting portion is placed below the horizontal line.

It is conceivable that at the brake caliper, the first portion and the second portion, which are respectively placed on the one side and the another side of the brake disc, are joined together through the connecting portion at the location that is on the radially outer side of the brake disc. In this case, there is concern that wear debris from the brake device may remain on an inner peripheral surface of the connecting portion, which faces the brake disc, in the installed state where the vehicle wheel drive device is installed to the vehicle. With respect to this point, in the installed state where the vehicle wheel drive device is installed to the vehicle, the vehicle wheel drive device is configured to satisfy one of the following conditions: the connecting portion is placed above the horizontal line which passes through the rotational center of the vehicle wheel; and the connecting portion does not intersect with the gravitational line, which passes through the rotational center of the vehicle wheel, in the state where at least the part of the connecting portion is placed below the horizontal line. With the above configuration, it is possible to limit the amount of wear debris of the brake device remaining on the inner peripheral surface of the connecting portion, which faces the brake disc.

According to a seventh aspect, there is provided the vehicle wheel drive device according to any one of the first to sixth aspects, wherein:
the stator includes:
   a plurality of stator windings; and
   a holder member that is shaped in a cylindrical tubular form and holds the plurality of stator windings;
the vehicle wheel drive device includes a winding connector member that is placed on one side of the plurality of stator windings which is opposite in the axial direction to another side of the plurality of stator windings where the brake caliper is fixed to the stator, wherein the winding connector member is electrically connected to each phase winding among the plurality of stator windings;
at least one relay line, which extends from the winding connector member, extends in the axial direction along an inner peripheral surface of the holder member; and
the at least one relay line extends through the hollow space at a location that is spaced from the brake caliper in a circumferential direction.

With respect to the structure, in which the winding connector member is placed on the one side of the plurality of stator windings which is opposite in the axial direction to the another side of the plurality of stator windings where the brake caliper is fixed to the stator, it is conceivable that the at least one relay line, which extends from the winding connector member, extends through the hollow space of the magnetic circuit unit and is pulled out from the hollow space. In this structure, the at least one relay line extends through the hollow space of the magnetic circuit unit at the location spaced from the brake caliper in the circumferential direction. In this case, the brake caliper and the at least one relay line are respectively installed at the corresponding locations spaced away from each other in the hollow space of the magnetic circuit unit, and thereby the heat sources are dispersed inside the hollow space, and thereby the cooling performance can be improved.

According to an eighth aspect, there is provided the vehicle wheel drive device according to the seventh aspect, wherein the inner peripheral surface of the holder member has a recess, through which the at least one relay line extends.

The inner peripheral surface of the holder member has the recess, through which the at least one relay line extends. Therefore, the at least one relay line can be pulled outwardly from the vehicle wheel drive device while ensuring the required brake disc diameter, i.e., without reducing the braking force caused by a reduction in the brake disc diameter.

According to a ninth aspect, there is provided the vehicle wheel drive device according to any one of the first to eighth aspects, wherein:
the brake caliper includes a first portion and a second portion which are separable from each other in the axial direction; and
the first portion and the second portion are independently fixed to the stator.

In the brake caliper, the first portion and the second portion, which are separable from each other in the axial direction, are independently fixed to the stator. In this case, at the hollow space of the magnetic circuit unit, the portion of the brake caliper on a depth side of the brake disc and the other portion of the brake caliper on an opposite side of the brake disc are separable from each other, and thereby the assembling work of these parts can be eased.

Hereinafter, an embodiment, in which a vehicle wheel drive device of the present disclosure is implemented as a vehicle wheel unit, will be described. The vehicle wheel unit is used as a drive wheel of a vehicle such as a 4-wheeled vehicle or a 2-wheeled vehicle. The vehicle wheel unit includes: a wheel frame to which a tire is installed; and a rotary electric machine (in-wheel motor) received in an inside space of the wheel frame.

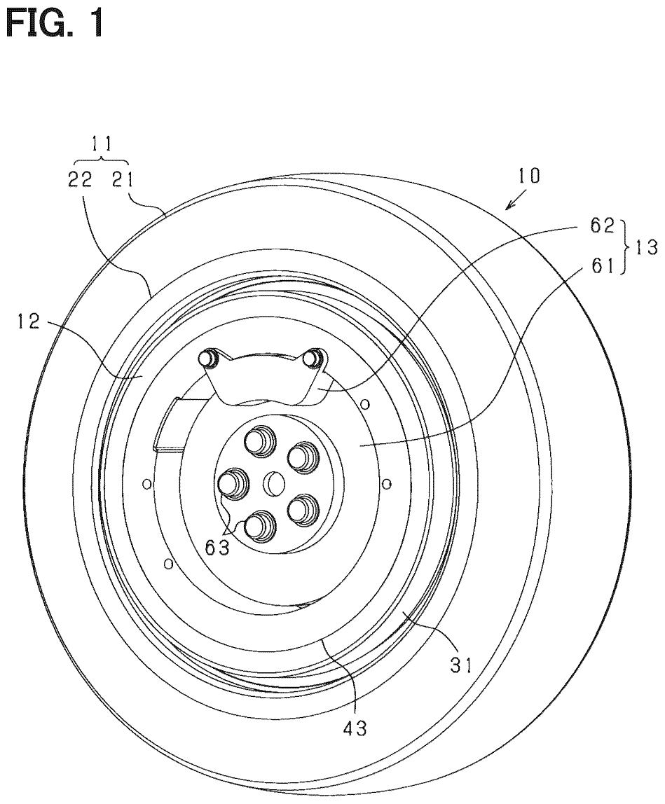

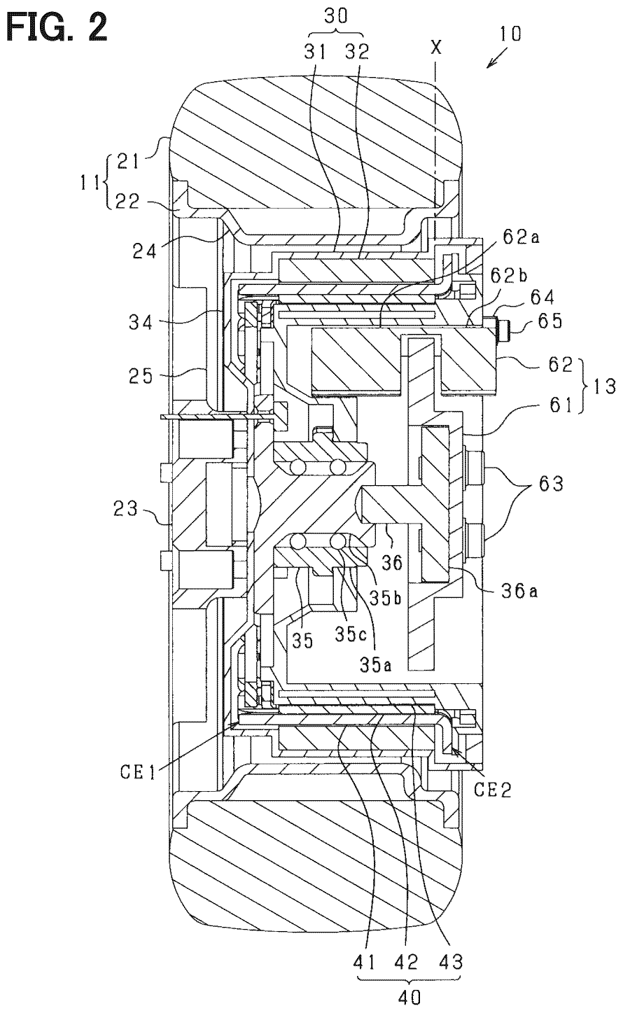

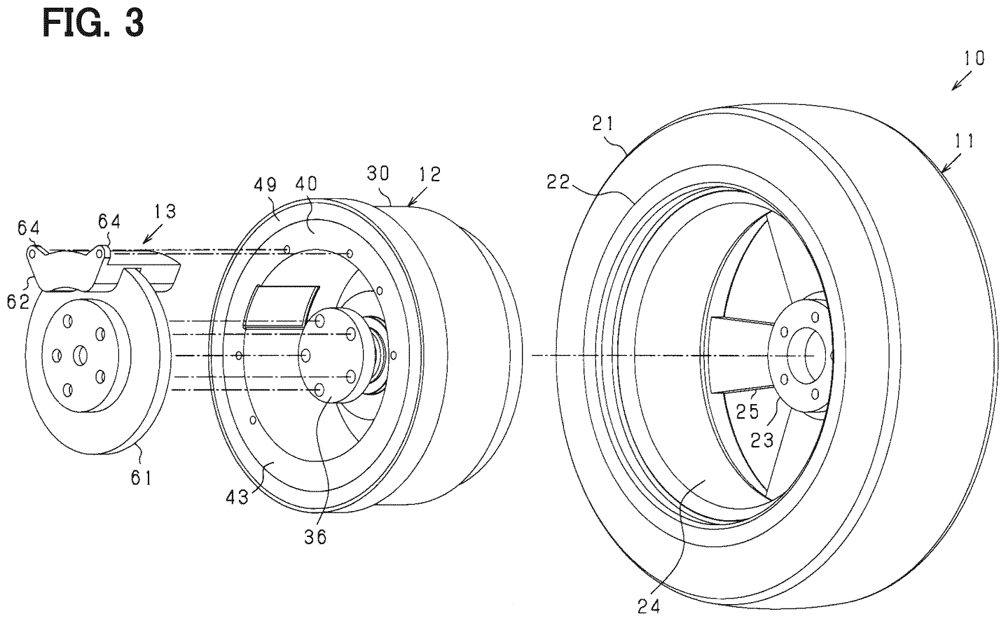

FIG. 1 is a perspective view showing an overall view of the vehicle wheel unit 10. FIG. 2 is a longitudinal cross-sectional view of the vehicle wheel unit 10. FIG. 3 is an exploded perspective view of the vehicle wheel unit 10. As shown in FIGS. 1 to 3, the vehicle wheel unit 10 includes: a vehicle wheel 11 shaped in a cylindrical tubular form; a rotary electric machine 12 configured to rotate the vehicle wheel 11; and a brake device 13 configured to brake the vehicle wheel 11. The rotary electric machine 12 is fixed to an inner periphery of the vehicle wheel 11. The rotary electric machine 12 includes: a stationary unit that includes a stator; and a rotatable unit that includes a rotor. The stationary unit is fixed to a vehicle body (not shown), and the rotatable unit is fixed to the vehicle wheel 11. The vehicle wheel 11 is rotated by rotating the rotatable unit. In the following description, an extending direction of a rotational axis of the rotary electric machine 12 (the vehicle wheel 11) is defined as an axial direction, and a direction, which radiates from the rotational axis, is defined as a radial direction. Furthermore, a direction, which extends circumferentially about the rotational axis, is defined as a circumferential direction. Details of the structures of the stationary unit and the rotatable unit of the rotary electric machine 12 will be described later. In the present embodiment, the rotary electric machine 12 and the brake device 13 correspond to the vehicle wheel drive device.

The vehicle wheel 11 includes: a tire 21; and a wheel frame 22 fixed to an inner periphery of the tire 21. The wheel frame 22 includes: a hub 23 that forms a rotational center of the vehicle wheel 11; a rim 24 that is shaped in a cylindrical tubular form and surrounds the hub 23; and a plurality of spokes 25 that couple between the hub 23 and the rim 24. The tire 21 is installed to an outer periphery of the rim 24. The hub 23 and the spokes 25 are located on one axial end side of the rim 24. The rotary electric machine 12 is received in an inside space of the rim 24 (an inside space of the wheel frame 22). The rotary electric machine 12 is installed in a state where the rotary electric machine 12 is fixed to the hub 23 of the wheel frame 22.

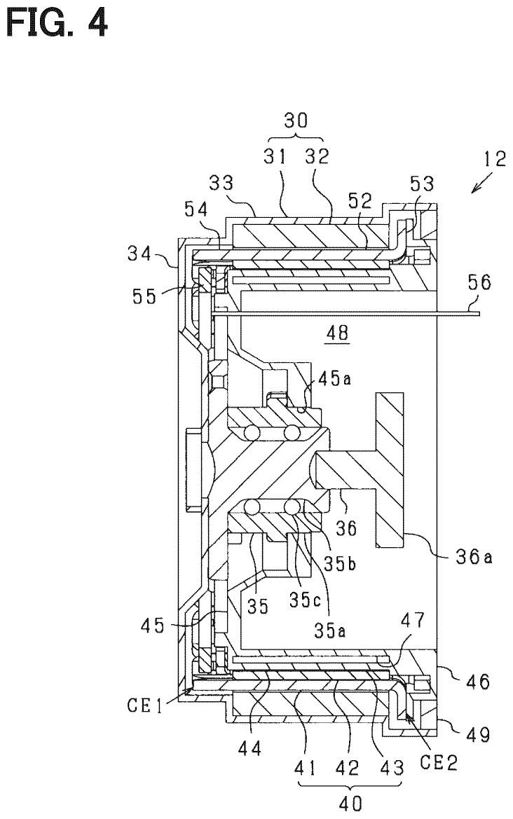

Hereinafter, the structure of the rotary electric machine 12 will be described. FIG. 4 is a longitudinal cross-sectional view of the rotary electric machine 12.

The rotary electric machine 12 is a surface permanent magnet motor of an outer rotor type and includes the rotor 30; and the stator 40 that is placed on a radially inner side of the rotor 30. The rotor 30 and the stator 40 are respectively shaped in a cylindrical tubular form and are opposed to each other such that an air gap shaped in a circular ring form is interposed between the rotor 30 and the stator 40.

The rotor 30 includes: a rotor carrier 31 that is shaped generally in a cylindrical tubular form; and a magnet unit 32 that is shaped in a ring form and is fixed to the rotor carrier 31. The magnet unit 32 serves as a magnetic flux generator. The rotor carrier 31 includes: a cylindrical tubular portion 33 that is shaped in a cylindrical tubular form; and an end plate portion 34 that is placed on one axial end side of the cylindrical tubular portion 33. The magnet unit 32 is fixed to an inner peripheral surface of the cylindrical tubular portion 33. The other axial end of the rotor carrier 31 is opened. The rotor carrier 31 serves as a magnet holder member.

The magnet unit 32 includes a plurality of magnets that are fixed to an inner peripheral surface of the cylindrical tubular portion 33 of the rotor carrier 31. In the magnet unit 32, the magnets are arranged such that magnetic polarities of the magnets are alternately inverted in the circumferential direction of the rotor 30. Therefore, a plurality of magnetic poles are arranged in the circumferential direction at the magnet unit 32. The magnet is, for example, an anisotropic permanent magnet and is a sintered neodymium magnet with an intrinsic coercive force of 400 [kA/m] or higher and a residual flux density Br of 1.0 [T] or higher. The rotary electric machine 12 may be an interior permanent magnet synchronous machine (IPMSM).

In the rotor carrier 31, a hub bearing 35 is fixed to an inner surface of the end plate portion 34, which is one of two opposed surfaces of the end plate portion 34 which are opposed to each other in the axial direction, and the one of the two opposed surfaces of the end plate portion 34 is placed on the cylindrical tubular portion 33 side. A shaft 36, which extends in the axial direction, is fixed to the hub bearing 35. The hub bearing 35 includes: an outer race (serving as a stationary portion) 35a; an inner race (serving as a rotatable portion) 35b; and a plurality of rolling elements (e.g., balls) 35c. The inner race 35b of the hub bearing 35 is fixed to the end plate portion 34. The shaft 36 is fixed to the inner race 35b such that the shaft 36 is integrally rotatable with the inner race 35b. The shaft 36 is placed on a radial center of the rotary electric machine 12 and has a circular plate portion 36a at a distal end portion of the shaft 36.

As shown in FIG. 2, the end plate portion 34 of the rotor carrier 31 is fixed to the hub 23 of the wheel frame 22 by fixture elements, such as bolts, and thereby the rotor 30 is assembled to the vehicle wheel 11. In the assembled state where the rotor 30 is assembled to the vehicle wheel 11, the shaft 36 is coaxial with the hub 23.

The stator 40 includes a plurality of stator windings 41, a stator core 42 and a stator holder 43. The stator core 42 and the stator holder 43 are integrated together such that the stator core 42 is placed on a radially outer side of the stator holder 43, and the stator windings 41 are installed on a radially outer side of the stator core 42 and the stator holder 43. The stator holder 43 serves as a holder member. Alternatively, an assembly of the stator core 42 and the stator holder 43 may serve as the holder member.

The stator windings 41 include a plurality of phase windings provided for a plurality of phases, respectively, and the phase windings are sequentially arranged at a predetermined sequence in the circumferential direction and are thereby shaped in a cylindrical tubular form. In the present embodiment, the stator windings 41 are three-phase windings of U-phase, V-phase and W-phase. The stator core 42 is shaped in a cylindrical tubular form and is formed as a back yoke.

In the present embodiment, the stator 40 has a teeth-less structure that does not have teeth which form slots. This structure may be one of the following structures (A) to (C).
(A) The stator 40 has a plurality of inter-conductor members, each of which is disposed between corresponding adjacent two of conductor portions (intermediate conductor portions 52 described later) in the circumferential direction. As the inter-conductor members, there is used a magnetic material which satisfies a relation of Wt×Bs≤Wm×Br where Wt is a width of the inter-conductor members in the circumferential direction within one magnetic pole, Bs is a saturation magnetic flux density of the inter-conductor members, Wm is a width of the magnet at the one magnetic pole in the circumferential direction, and Br is a residual magnetic flux density of the magnets of the magnet unit 32.
(B) The stator 40 has the inter-conductor members, each of which is disposed between the corresponding adjacent two of the conductor portions in the circumferential direction. The inter-conductor members are made of a non-magnetic material.
(C) The stator 40 has no inter-conductor member disposed between the conductor portions in the circumferential direction.

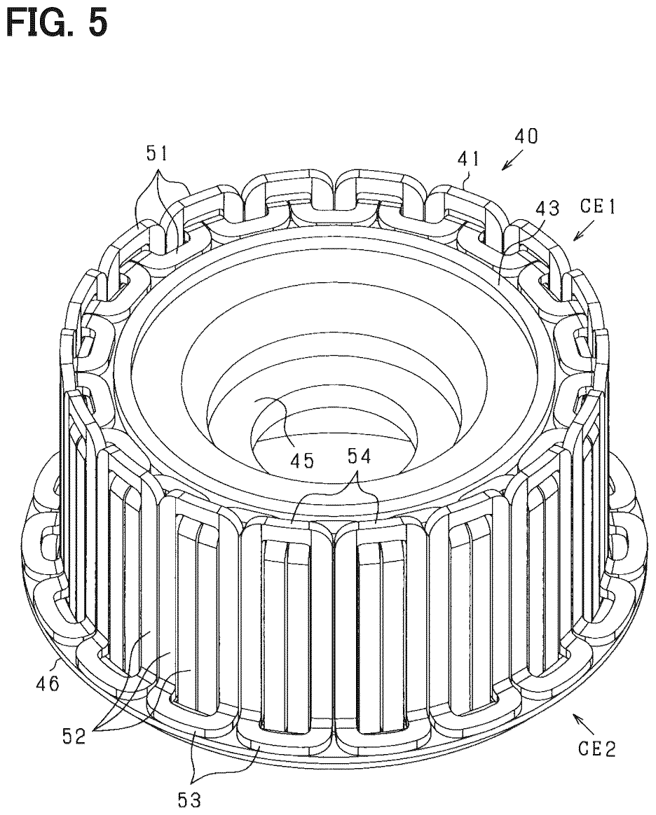

Next, the structure of the stator windings 41 of the present embodiment will be described with reference to FIG. 5.

Each of the stator windings 41 includes a plurality of winding segments 51 each serving as a unit coil, and the winding segments 51 are arranged in the circumferential direction to form the stator winding 41. Each winding segment 51 is formed by winding a conductor wire a plurality of times. Each winding segment 51 includes: a pair of intermediate conductor portions 52 which are parallel to each other and extend in the axial direction; and a pair of link portions 53, 54 each of which connects between corresponding axial ends of the intermediate conductor portions 52 at a corresponding one of two opposite axial ends of the intermediate conductor portions 52. The winding segment 51 is shaped in a ring form by the pair of intermediate conductor portions 52 and the pair of link portions 53, 54.

The link portions 53, 54, which are respectively placed at the two axial end sides, are respectively formed as a portion that corresponds to a corresponding one of coil end portions CE1, CE2. Among the pair of link portions 53, 54, the link portion 53 is radially bent, and the link portion 54 is not radially bent. The winding segments 51 include a first plurality of winding segments 51, in each of which the link portion 53 is radially inwardly bent, and a second plurality of winding segments 51, in each of which the link portion 53 is radially outwardly bent. In the stator 40, at the coil end portion CE1 located at the one side (the upper side in FIG. 5) in the axial direction, the link portion 53 of each of the first plurality of winding segments 51 is radially inwardly bent. Furthermore, at the other coil end portion CE2 located at the other side (the lower side in FIG. 5) in the axial direction, the link portion 53 of each of the second plurality of winding segments 51 is radially outwardly bent.

Referring back to FIG. 4, the stator holder 43 includes: a cylindrical tubular portion 44 which is installed on a radially inner side of the stator core 42; an end plate portion 45 which is placed at one axial end portion of the cylindrical tubular portion 44 at a location that is on a radially inner side of the cylindrical tubular portion 44; and a flange 46 which is placed at the other axial end portion of the cylindrical tubular portion 44 and radially outwardly projects from the cylindrical tubular portion 44. In the stator holder 43, the end plate portion 45 is formed on the same side as the end plate portion 34 of the rotor carrier 31 in the axial direction. Therefore, the end plate portion 34 of the rotor carrier 31 and the end plate portion 45 of the stator holder 43 are opposed to each other at the one side in the axial direction, and the rotor carrier 31 and the stator holder 43 are opened at the other side in the axial direction.

The cylindrical tubular portion 44 has a refrigerant passage 47 that conducts a refrigerant, such as a coolant. The refrigerant passage 47 extends straight in the axial direction and is shaped in a ring form along the cylindrical tubular portion 44 to conduct the refrigerant in the circumferential direction between an inlet and an outlet of the refrigerant passage 47.

The end plate portion 45 has a hole 45a at a center portion of the end plate portion 45. The hub bearing 35 (more specifically, the outer race 35a of the hub bearing 35) is assembled to the hole 45a. Therefore, the rotor carrier 31 (the rotor 30) and the shaft 36 are supported in a rotatable manner relative to the stator holder 43 (the stator 40).

The flange 46 is placed on the outer side of the stator windings 41 in the axial direction, i.e., the outer side of the link portions 53, 54 in the axial direction. Desirably, the flange 46 has a position limiting function for limiting the position of the respective link portions 53, 54. Specifically, the flange 46 may have engaging portions which are engaged with the link portions 53, 54 of the respective winding segments 51 to limit at least one of axial position, a radial position and a circumferential position of the respective winding segments 51.

In the stator 40, a cavity 48 is formed on a radially inner side of the cylindrical tubular portion 44 of the stator holder 43. The cavity 48 serves as a hollow space formed on a radially inner side of a magnetic circuit unit that is formed by the rotor 30 and the stator 40. In the present embodiment, since the stator 40 has the teeth-less structure, a radial thickness of the stator 40 can be reduced to enable an increase in a size of the cavity 48.

At the opening end of the rotor carrier 31, the rotor carrier 31 and the stator holder 43 radially form a double walled structure, and an end ring 49, which is shaped in a circular ring form, is installed in a gap formed between the rotor carrier 31 and the stator holder 43.

Furthermore, as shown in FIG. 4, a wiring module (serving as a winding connector member) 55, which is electrically connected to each of the winding segments 51 of the stator windings 41, is installed to the stator 40. The wiring module 55 is shaped in a circular ring form and has wiring members, such as busbars, provided for the respective phases. The wiring module 55 connects the winding segments 51 of the phase windings in parallel or in series for each phase and makes a neutral point connection of the phase windings. Among the coil end portions CE1, CE2, which are located at two opposite axial sides, respectively, of the stator 40, the wiring module 55 is placed on the coil end portion CE1 side that is opposite to the opening of the stator holder 43. The coil end portion CE1 is located on the side where the link portions 53 of the corresponding winding segments 51 are radially inwardly bent.

A plurality of electric power lines 56 of the respective phases are connected to the wiring module 55. In a state where one end of each electric power line 56 is connected to the wiring module 55, each electric power line 56 extends in the axial direction through the inside of the stator holder 43. The electric power lines 56 extend from the coil end portion CE1 side toward the coil end portion CE2. The electric power lines 56 serve as relay lines. The electric power lines 56 of the respective phases are connected to an inverter (not shown) to enable input/output of an electric power therebetween. An electric current sensor, which is configured to sense a phase electric current of each phase, may be integrally provided to the wiring module 55. Furthermore, sensor signal lines may be included in the electric power lines 56.

Next, the brake device 13 will be described with reference to FIGS. 2 and 3.

The brake device 13 is a friction brake device of a disc type and includes a brake disc 61 shaped in a circular plate form and a brake caliper 62. Since the structure of the brake device 13 itself is well known, a detailed description by way of illustration is omitted. The brake disc 61 may be, for example, a solid disc, which is made of a single circular plate, or a ventilated disc, which has a cavity for ventilation at an inside thereof. The brake caliper 62 includes: a pair of brake pads that are activated by, for example, a hydraulic pressure or an electrical signal and contact the brake disc 61 to generate a braking force; a piston that urges the brake pads against the brake disc 61; and a caliper body that supports the brake pads and the piston.

The brake disc 61 is fixed to the distal end portion (the circular plate portion 36a) of the shaft 36, which is rotated integrally with the rotor 30, by fixture elements 63, such as bolts. In this case, the brake disc 61 is coupled to the rotor carrier 31 through the shaft 36 and the hub bearing 35. Therefore, influences of the braking torque relative to the rotor 30 can be alleviated as compared to a structure in which the brake disc 61 is directly coupled to the rotor carrier 31. In other words, deformation, etc. of the rotor carrier 31 caused by the braking torque is limited. The heat, which is generated during the operation of the brake device 13, is less likely to be conducted to the rotor 30 as compared to the structure in which the brake disc 61 is directly coupled to the rotor carrier 31.

The distal end portion of the shaft 36 extends to a middle location in the axial direction at the inside of the cylindrical tubular portion 44 of the stator holder 43. In the state where the brake disc 61 is fixed to the distal end portion of the shaft 36, the brake disc 61 is entirely received in the cavity 48. In this case, the brake disc 61 is received in the cavity 48 at a position where at least a part of the brake disc 61 is placed closer to the axial center (closer to the left side in the drawing) relative to an axial position X at which an axial end surface of the magnet unit 32 of the rotor 30 is placed. In terms of its positional relationship with respect to the wheel frame 22, the brake disc 61 may be entirely received on the radially inner side of the rim 24. However, the structure described above may be modified such that only a portion of the brake disc 61 is received in the cavity 48, or only a portion of the brake disc 61 is received on the radially inner side of the rim 24.

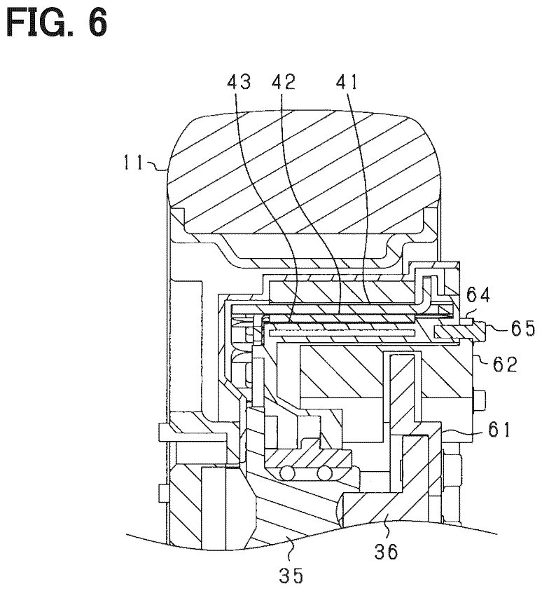

As shown in FIG. 6, the brake caliper 62 has a fixing portion 64 that is fixed to the stator holder 43 in a state where the fixing portion 64 is in contact with an axial end surface of the stator holder 43. The brake caliper 62 is fixed to the stator holder 43 at the fixing portion 64 by fixture elements 65, such as bolts. In other words, the brake caliper 62 except at least the fixing portion 64 is received in the inside of the cylindrical tubular portion 44 of the stator holder 43, i.e., in the cavity 48. In this case, the fixing work for fixing the fixing portion 64 relative to the axial end surface of the stator holder 43 can be performed from the outside of the vehicle wheel 11. Furthermore, during the operation of the brake device 13, the heat, which is generated from the brake caliper 62, is directly conducted to the stator holder 43 through the fixing portion 64. This allows the brake device 13 to be cooled through the stator holder 43.

Although the heat generation of the stator 40 and the heat radiation of the brake caliper 62 are balanced during the normal driving of the vehicle, the rotary electric machine 12 stops during emergency braking of the vehicle. Therefore, in such a state, the cooling capacity of the stator 40 is used entirely for the brake cooling.

The brake caliper 62 is straddling over the brake disc 61 and is thereby present on each of the two opposite sides of the brake disc 61. The brake caliper 62 includes: an inner portion 62a, which is opposed to a first surface of the brake disc 61 that faces the axial center of the cavity 48; and an outer portion 62b, which is opposed to a second surface of the brake disc 61 that faces the outer side of the cavity 48. The brake pads are installed to the inner portion 62a and the outer portion 62b, respectively, and the piston is installed to the inner portion 62a. The inner portion 62a and the outer portion 62b are coupled to each other by a connecting portion 62c of the caliper body at a location that is on the radially outer side of the brake disc 61. The brake caliper 62 has an external straddling structure in which the caliper body is straddled over the brake disc 61 at the location that is on the radially outer side of the brake disc 61. The inner portion 62a serves as a first portion, and the outer portion 62b serves as a second portion.

Although not depicted in the drawing, in order to operate the piston, for example, a hydraulic oil pipe is connected to the brake caliper 62. The hydraulic oil pipe may be arranged on the radially outer side of the brake disc 61.

At the time of assembling the brake device 13 to the rotary electric machine 12, the assembling may be carried out in a state where the brake disc 61 is set to the brake caliper 62, i.e., in the state shown in FIG. 3 where the brake disc 61 and the brake caliper 62 are integrated together.

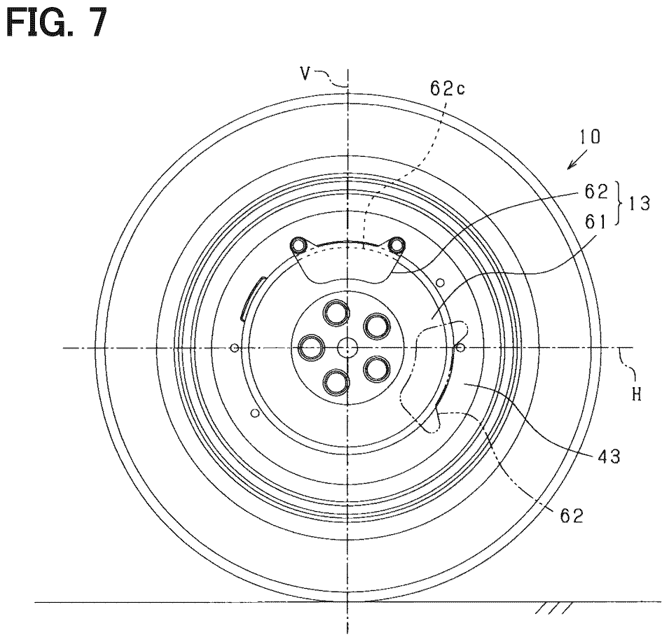

FIG. 7 is a front view showing an installed state of the vehicle wheel unit 10 on the vehicle. In the state of FIG. 7, the brake device 13 is installed at the position where the brake caliper 62 is placed at the upper side of the brake device 13 in the gravitational direction. More specifically, in the brake device 13, the connecting portion 62c of the brake caliper 62 is placed above a horizontal line H which passes through the rotational center (rotational axis) of the vehicle wheel. Here, as indicated by a virtual line in FIG. 7, it may be configured such that the connecting portion 62c does not intersect with a gravitational line V which extends through the rotational center of the vehicle wheel in a state where at least a part of the connecting portion 62c of the brake caliper 62 is placed below the horizontal line H. In this case, even when wear debris is generated by frictional braking of the brake caliper 62 (brake pads) relative to the brake disc 61, the wear debris is likely to be discharged from the inside of the connecting portion 62c (the inner peripheral surface of the connecting portion 62c on the brake disc 61 side), thereby making it possible to limit the amount of wear debris remaining on the brake caliper 62.

The brake device 13 is installed in the state where the brake device 13 is received in the cavity 48 of the rotary electric machine 12, i.e., in the hollow space at the inside of the magnetic circuit unit of the rotary electric machine 12. In this case, in the installed state where the brake device 13 is assembled to the rotary electric machine 12, the brake caliper 62, the stator 40, the air gap and the rotor 30 are arranged in this order in the radial direction in a view taken from the rotational axis side. With this configuration, the heat releasing portion (the refrigerant passage 47) of the stator holder 43 and the air gap are present in a region between the brake caliper (the heat generating portion) 62 and the rotor 30 (magnets), and thereby the heat, which is generated from the brake caliper 62, is less likely to be conducted to the rotor 30 (the magnets), thereby limiting demagnetization of the magnets.

As shown in FIG. 2, the stator 40 is assembled such that the coil end portion CE1 is placed closer to the hub 23 in the axial direction than the coil end portion CE2, and the coil end portion CE2 is placed farther from the hub 23 in the axial direction than the coil end portion CE1. In this state, the rotor 30 is placed on the radially outer side of the stator 40, and the brake device 13 is fixed in a state where the brake device 13 is inserted on the radially inner side of the stator 40 from a side of the stator 40 where the coil end portion CE2 is placed. In this case, the brake device 13 can be assembled to the stator 40 from the side of the stator 40 where the coil end portion CE2 is placed.

The hub bearing 35 and the shaft 36 are installed to one of the two opposed surfaces of the end plate portion 34 which faces the cavity 48. In this case, the brake caliper 62 is placed in a position where the brake caliper 62 radially overlaps with the hub bearing 35, and the cavity 48 is a receiving area for receiving the brake device 13 and the hub bearing 35.

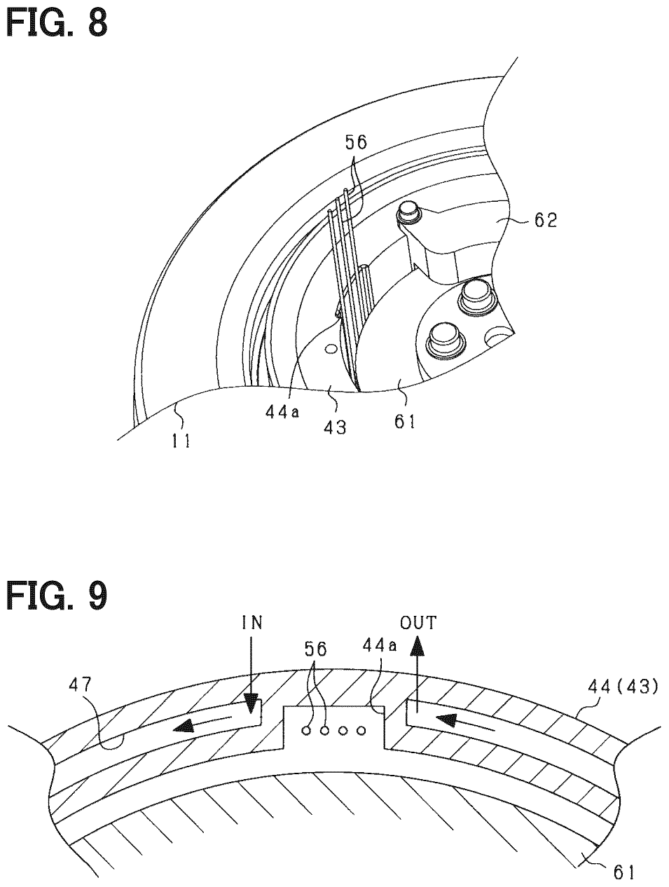

In the case described above where the wiring module 55 is placed on the coil end portion CE1 side opposite to the opening of the stator holder 43, the electric power lines 56, which are connected to the wiring module 55, extend through the radially inner side of the stator holder 43 and extend outwardly from the opening of the stator holder 43. FIG. 8 shows the structure described above.

As shown in FIG. 8, an inner peripheral surface of the cylindrical tubular portion 44 of the stator holder 43 has a recess 44a which extends in the axial direction. The electric power lines 56 extend outwardly from the opening of the stator holder 43 in a state where the electric power lines 56 are received in the recess 44a. With this configuration, the electric power lines 56 are pulled outwardly from the vehicle wheel 11 while ensuring the required brake disc diameter, i.e., without reducing the braking force caused by a reduction in the brake disc diameter.

A circumferential location of the recess 44a in the stator holder 43, i.e., the insertion location of the electric power lines 56 in the cavity 48, is spaced from the brake caliper 62 in the circumferential direction. Therefore, the heat sources are dispersed inside the cavity 48, and thereby the cooling performance can be improved.

Taking into account that the stator holder 43 has the refrigerant passage 47 shaped in the ring form, the recess 44a should be located at the position that does not overlap with the refrigerant passage 47 in the circumferential direction. This configuration will be described with reference to FIG. 9 showing the transverse cross-section of the stator holder 43. In FIG. 9, the refrigerant passage 47 shaped in the ring form is formed in the cylindrical tubular portion 44 of the stator holder 43, and one circumferential end of the refrigerant passage 47 is a passage inlet, and the other circumferential end of the refrigerant passage 47 is a passage outlet. In this case, a portion of the cylindrical tubular portion 44, which is located between the passage inlet and the passage outlet of the refrigerant passage 47, has a locally increased wall thickness and thereby serves as a thick wall portion, and the recess 44a is formed at this thick wall portion. Therefore, the electric power lines 56 can be pulled out in a suitable manner.

The shaft 36 may be provided with a rotation sensing device 37, such as a resolver. In this case, since the brake device 13 is placed in the cavity 48 in the present embodiment, an accommodation space for accommodating the rotation sensing device 37 is limited. Therefore, an SRX (Semiconductor Resolver) sensor may be used as the rotation sensing device 37. This allows for proper placement of the rotation sensing device 37 while making the vehicle wheel unit 10 compact.

The embodiment described above can achieve the following advantages.

By installing the brake device 13 in the hollow space (cavity 48) of the magnetic circuit unit in the rotary electric machine 12, the axial length of the vehicle wheel unit 10 can be reduced. Furthermore, by fixing the brake caliper 62 to the axial end surface of the stator 40, the fixing structure of the brake caliper 62 can be simplified, and the installation of the brake device 13 into the hollow space can be suitably executed. As a result, the brake device 13 can be suitably installed in the vehicle wheel unit 10 having the in-wheel motor structure.

The brake caliper 62 is fixed to the axial end surface of the stator 40 at the fixing portion 64, and in this fixed state, the brake caliper 62 is installed in the hollow space of the magnetic circuit unit. In this case, while the axial length is shortened by receiving the brake caliper 62 in the hollow space, the fixing work for fixing the fixing portion 64 to the axial end surface of the stator 40 from the outside of the vehicle wheel is made possible, thereby improving the workability for installing the brake caliper 62.

In the state where the rotor 30 is fixed to the hub 23 of the wheel frame 22, the rotary electric machine 12 is placed on the radially inner side of the rim 24. Furthermore, in the hollow space of the magnetic circuit unit, the brake disc 61 is fixed to the shaft 36 installed coaxially with the hub 23. In this case, the braking torque, which is generated by the frictional braking to the brake disc 61, does not act directly on the rotor 30 during the operation of the brake device 13. Therefore, it is possible to limit deformation, etc. of the rotor 30 caused by the braking torque.

The relative rotation between the stator 40 and the rotor 30 is made possible by the hub bearing 35. Specifically, the outer race 35a (the stationary portion) of the hub bearing 35 is coupled to the stator 40, and the inner race 35b (the rotatable portion) of the hub bearing 35 is coupled to the end plate portion 34 of the rotor carrier 31. The hub bearing 35 and the shaft 36 are installed to the one of the two opposed surfaces of the end plate portion 34 which faces the hollow space of the magnetic circuit unit. In this case, the hollow space of the magnetic circuit unit can be suitably used as the receiving area of the brake device 13 and the hub bearing 35.

At the coil end portion CE1, the axial end portion of each corresponding one of the stator windings 41 (each corresponding one of the winding segments 51) is radially inwardly bent, and at the coil end portion CE2, the axial end portion of each corresponding one of the stator windings 41 (each corresponding one of the winding segments 51) is radially outwardly bent. Also, the stator 40 is installed in the state where the coil end portion CE1 is placed closer to the hub 23 in the axial direction than the coil end portion CE2, and the coil end portion CE2 is placed farther from the hub 23 in the axial direction than the coil end portion CE1. Furthermore, the rotor 30 is placed on the radially outer side of the stator 40, and the brake device 13 is fixed in the state where the brake device 13 is inserted on the radially inner side of the stator 40 from the side of the stator 40 where the coil end portion CE2 is placed. In this case, by radially bending the axial end portions of the stator windings 41, it is possible to suitably arrange the stator windings 41 while limiting the interferences among the phase windings. Furthermore, it is possible to assemble the rotor 30 to the stator 40 from the one side in the axial direction, and it is also possible to assemble the brake device 13 to the stator 40 from the other side in the axial direction.

In the installed state where the vehicle wheel unit 10 is installed to the vehicle, the vehicle wheel unit 10 is configured to satisfy one of the following conditions: the connecting portion 62c of the brake caliper 62 is placed above the horizontal line H which passes through the rotational center of the vehicle wheel; and the connecting portion 62c does not intersect with the gravitational line V, which passes through the rotational center of the vehicle wheel, in the state where at least the part of the connecting portion 62c is placed below the horizontal line H. With the above configuration, it is possible to limit the amount of wear debris remaining on the brake device 13.

The electric power lines 56 extend through the hollow space of the magnetic circuit unit at the location spaced from the brake caliper 62 in the circumferential direction. In this case, the brake caliper 62 and the electric power lines 56 are respectively installed at the corresponding locations spaced away from each other in the hollow space of the magnetic circuit unit, and thereby the heat sources are dispersed inside the hollow space, and thereby the cooling performance can be improved.

The inner peripheral surface of the stator holder 43 has the recess 44a, through which the electric power lines 56 extend. Therefore, the electric power lines 56 can be pulled outwardly from the vehicle wheel while ensuring the required brake disc diameter, i.e., without reducing the braking force caused by the reduction in the brake disc diameter.

### Modifications

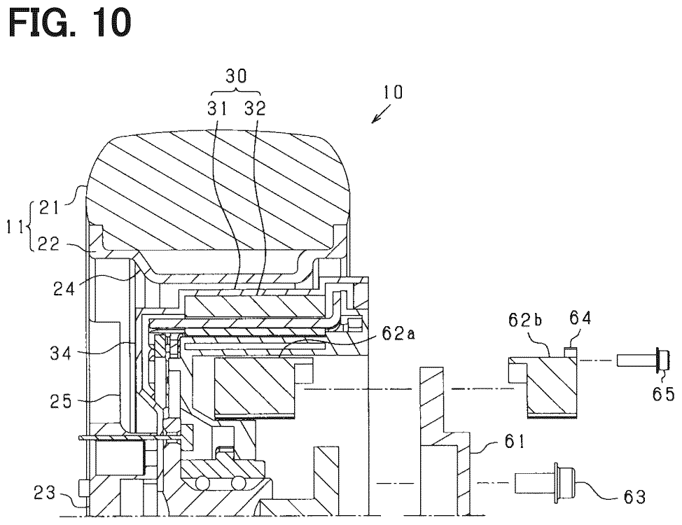

The brake caliper 62 may be formed such that the inner portion 62a and the outer portion 62b are separable from each other in the axial direction, and the inner portion 62a and the outer portion 62b are independently fixed to the stator holder 43. Specifically, as shown in FIG. 10, the inner portion 62a of the brake caliper 62 is fixed to the inner peripheral surface of the stator holder 43, and thereafter, the brake disc 61 is fixed to the shaft 36. Then, the outer portion 62b of the brake caliper 62 is fixed to the axial end surface of the stator holder 43. In this case, the portion of the brake caliper 62 on the depth side (the end plate 45 side) of the brake disc 61 and the other portion of the brake caliper 62 on the opposite side (the side opposite to the end plate 45) of the brake disc 61 are separable from each other, and thereby the assembling work of these parts can be eased.

The brake device 13 may be configured such that a plurality of brake calipers 62 are provided to the single brake disc 61. Furthermore, a plurality of brake discs 61 may be provided to the shaft 36. By providing the plurality of brake discs 61 and/or the plurality of brake calipers 62 at the brake device 13, the braking force at the in-wheel motor can be increased.

In the embodiment described above, the piston is provided to the inner portion 62a among the inner portion 62a and the outer portion 62b of the brake caliper 62. This configuration may be modified such that the piston is provided to the outer portion 62b.

The stator windings 41 are not limited to the stator windings that use the plurality of winding segments 51, and the stator windings 41 may be formed with conductor lines wound in a wave winding pattern. In this case, the stator windings 41, which are shaped in a cylindrical tubular form through the wave winding, may be assembled to the stator core 42 shaped in a cylindrical tubular form.

In each of the embodiments described above, the surface permanent magnet rotor is used as the rotor 30. Alternatively, an interior permanent magnet rotor or an electrically excited rotor may be used as the rotor 30.

In each of the embodiments described above, the rotary electric machine is the outer rotor type. Alternatively, the rotary electric machine may be an inner rotor type. In the inner rotor type rotary electric machine, the stator is placed radially outside, and the rotor is placed radially inside.

The disclosure in this specification is not limited to the illustrated embodiments. The disclosure encompasses the illustrated embodiments and variations, which are conceivable by those skilled in the art based on the illustrated embodiment(s). For example, the disclosure is not limited to the combination of the components and/or elements indicated in the embodiments. The disclosure can be implemented in a variety of combinations. The disclosure may have additional parts that can be added to the embodiment(s). The disclosure includes variations, in which some of the components and/or elements of the embodiment(s) is/are omitted. The disclosure encompasses the replacement or combination of the components and/or elements between one of the embodiments and another one of the embodiments. The disclosed technical scope is not limited to the technical scope described in the embodiment(s). Some disclosed technical scope should include the technical scope indicated by the statement of claim(s) and all of equivalents to the technical scope indicated by the statement of claim(s).

Although the present disclosure has been described with reference to the embodiments and the modifications, it is understood that the present disclosure is not limited to the embodiments and the modifications and structures described therein. The present disclosure also includes various variations and variations within the equivalent range. Also, various combinations and forms, as well as other combinations and forms that include only one element, more, or less, are within the scope and ideology of the present disclosure.

What is claimed is:

1. A vehicle wheel drive device comprising:
a rotary electric machine that is received on a radially inner side of a vehicle wheel shaped in a cylindrical tubular form, wherein the rotary electric machine is configured to rotate the vehicle wheel; and
a brake device that includes a brake disc and a brake caliper, wherein the brake device is configured to generate a braking force relative to the vehicle wheel, wherein:
the rotary electric machine includes a rotor and a stator which are opposed to each other in a radial direction;
a hollow space is formed on a radially inner side of a magnetic circuit unit that is formed by the rotor and the stator; and
the brake device is installed in the hollow space in a state where the brake caliper is fixed to an axial end surface of the stator which faces in an axial direction, and the brake disc is rotatable integrally with the rotor.

2. The vehicle wheel drive device according to claim 1, wherein:
the stator includes:
a plurality of stator windings; and
a holder member that is shaped in a cylindrical tubular form and holds the plurality of stator windings; and
the brake caliper includes a fixing portion that is fixed to the axial end surface of the stator, and the brake caliper is installed in a state where the brake caliper is received in the hollow space and is fixed to the stator through the fixing portion.

3. The vehicle wheel drive device according to claim 1, wherein:
the vehicle wheel includes a wheel frame, wherein the wheel frame includes:
a hub that forms a rotational center of the vehicle wheel; and
a rim that is shaped in a cylindrical tubular form and surrounds the hub;
the rotary electric machine is placed on a radially inner side of the rim in a state where the rotor is fixed to the hub;
the vehicle wheel drive device comprises a shaft that is coaxial with the hub; and
the brake disc is fixed to the shaft at the hollow space.

4. The vehicle wheel drive device according to claim 3, comprising a hub bearing that is fixed to the hub, wherein:
the rotor includes:
a rotor carrier that is shaped in a cylindrical tubular form; and
a magnetic flux generator that is fixed to the rotor carrier;
the rotor carrier has an end plate portion that is formed at an axial end portion of the rotor carrier;
a stationary portion of the hub bearing is coupled to the stator;
a rotatable portion of the hub bearing is coupled to the end plate portion of the rotor carrier; and
the end plate portion has two opposed surfaces which are opposed to each other, and the hub bearing and the shaft are installed to one of the two opposed surfaces of the end plate portion which faces the hollow space.

5. The vehicle wheel drive device according to claim 3, wherein:
the stator includes a plurality of stator windings;
at a first coil end portion of the plurality of stator windings which faces one side in the axial direction, an axial end portion of each corresponding one of the plurality of stator windings is radially inwardly bent, and at a second coil end portion of the plurality of stator windings which faces another side that is opposite to the one side in the axial direction, an axial end portion of each corresponding one of the plurality of stator windings is radially outwardly bent;
the stator is installed in a state where the first coil end portion is placed closer to the hub in the axial direction than the second coil end portion, and the second coil end portion is placed farther from the hub in the axial direction than the first coil end portion; and
the rotor is placed on a radially outer side of the stator, and the brake device is fixed in a state where the brake device is inserted on a radially inner side of the stator from a side of the stator where the second coil end portion is placed.

6. The vehicle wheel drive device according to claim 1, wherein:
the brake caliper includes a first portion and a second portion which are respectively placed on one side and another side of the brake disc in the axial direction;
the first portion and the second portion are joined together through a connecting portion at a location that is on a radially outer side of the brake disc; and
in an installed state where the vehicle wheel drive device is installed to a vehicle, the vehicle wheel drive device is configured to satisfy one of the following conditions:
the connecting portion is placed above a horizontal line which passes through a rotational center of the vehicle wheel; and
the connecting portion does not intersect with a gravitational line, which passes through the rotational center of the vehicle wheel, in a state where at least a part of the connecting portion is placed below the horizontal line.

7. The vehicle wheel drive device according to claim 1, wherein:
the stator includes:
a plurality of stator windings; and
a holder member that is shaped in a cylindrical tubular form and holds the plurality of stator windings;
the vehicle wheel drive device comprises a winding connector member that is placed on one side of the plurality of stator windings which is opposite in the axial direction to another side of the plurality of stator windings where the brake caliper is fixed to the stator, wherein the winding connector member is electrically connected to each phase winding among the plurality of stator windings;
at least one relay line, which extends from the winding connector member, extends in the axial direction along an inner peripheral surface of the holder member; and
the at least one relay line extends through the hollow space at a location that is spaced from the brake caliper in a circumferential direction.

8. The vehicle wheel drive device according to claim 7, wherein the inner peripheral surface of the holder member has a recess, through which the at least one relay line extends.

9. The vehicle wheel drive device according to claim 1, wherein:
the brake caliper includes a first portion and a second portion which are separable from each other in the axial direction; and
the first portion and the second portion are independently fixed to the stator.
